(19) United States
(12) Patent Application Publication
(10) Pub. No.: US 2009/0002405 A1
(43) Pub. Date: Jan. 1, 2009

(54) DISPLAY DRIVE APPARATUS, DISPLAY APPARATUS AND DRIVE CONTROL METHOD THEREOF

(75) Inventor: Tsuyoshi OZAKI, Fuchu-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/146,625

(22) Filed: Jun. 26, 2008

(30) Foreign Application Priority Data
Jun. 29, 2007 (JP) 2007-172317

(51) Int. Cl. G09G 5/10

(52) U.S. Cl. 345/690

(57) ABSTRACT

A display drive apparatus driving a display pixel, includes a light-emitting element and a light-emission drive element, connected to a data line, includes a reset circuit and a gradation current supply circuit. The reset circuit initializes the display pixel applying a reset voltage to the display pixel wherein the reset voltage has a voltage value that an absolute value of a potential difference applied between a control terminal of the light-emission drive element and one end of the current path thereof being a larger value than an absolute value of a threshold voltage of the light-emission drive element, and has a polarity capable of discharging charge remaining in wiring capacitance of the data line and a capacitance component of the display pixel. The gradation current supply circuit supplies a gradation current having a signal polarity and magnitude corresponding to a gradation value of display data to the display pixel initialized.

### CROSS-REFERENCE TO RELATED APPLICATIONS

This application is based upon and claims the benefit of priority from prior Japanese Patent Application No. 2007-172317, filed Jun. 29, 2007, the entire contents of which are incorporated herein by reference.

### BACKGROUND OF THE INVENTION

1. Field of the Invention

The present invention relates to a display drive apparatus, a display apparatus having the display drive apparatus and a drive control method thereof, and in particular, to a display drive apparatus which drives display pixels each having a light-emitting element of current control type for emitting light at a desired brightness gradation by supplying a predetermined current, a drive control method thereof, a display apparatus which drives a display panel having an array of a plurality of the display pixels with the display drive apparatus, and a drive control method thereof.

2. Description of the Related Art

A display (display apparatus) of light-emitting element type such as an organic electroluminescent element (hereinafter referred to as “the organic EL element”) or a light-emitting diode (LED) is known, which includes a display panel having, on the substrate thereof, a two-dimensional array of display pixels each with a light-emitting element of current control type for emitting light at a predetermined brightness gradation in accordance with the drive current supplied thereto.

With regard to this display of light-emitting element type, various drive control mechanisms and control methods for controlling the light emission of the light-emitting element of current control type described above have been proposed. A drive control mechanism including, for each of display pixels making up a display panel, a drive circuit (pixel drive circuit) having a plurality of light-emitting elements and transistor elements (switching elements) for controlling the light emission of the light-emitting elements is a known example.

The drive control method for a display panel having an array of display pixels with a drive circuit includes a current designation method in which a gradation current designated in accordance with the display data is supplied to the drive circuit of each display pixel thereby to emit light from the light-emitting element at a predetermined brightness gradation.

In the display apparatus using the drive control method of current designation type described above, however, the operation of supplying and writing the display data (gradation current) in each display pixel requires the corresponding operation of charging a parasitic wiring capacitance on the data lines or a holding capacitance or the like arranged in the display pixel to a predetermined voltage. Especially in the write operation in a low gradation area where the gradation current is reduced, therefore, a writing failure is liable to occur in which the display data cannot be sufficiently written within a predetermined write time. Further, the operation characteristic of the switching circuit arranged in the drive circuit of each display pixel is degraded. Specifically, with the increase in the threshold voltage variation of the thin-film transistor connected in series to the light-emitting element for supplying the light-emission drive current, the light-emission drive current supplied to the light-emitting element from the drive circuit is reduced, resulting in degraded image quality.

### BRIEF SUMMARY OF THE INVENTION

An object of the invention is to provide a display drive apparatus using the drive control method of current designation type and a display apparatus using the display drive apparatus, wherein even in the case where the operation characteristic of the light-emission drive element in the pixel drive circuit of each display pixel is degraded, the light-emitting element can emit light at proper gradation corresponding to the display data, thereby making it possible to suppress the degradation of the display image quality.

In order to achieve the above-described object, a display drive apparatus according to the present invention for driving a display pixel connected to a data line, the display pixel includes a light-emitting element and a pixel drive circuit including a light-emission drive element having a current path connected to one end of the light-emitting element, comprises:

a reset circuit which initializes the display pixel by applying a reset voltage to the display pixel through the data line, wherein the reset voltage has a voltage value that an absolute value of a potential difference applied between a control terminal of the light-emission drive element and one end of the current path connected to the one end of the light-emitting element being a larger value than an absolute value of a threshold voltage of the light-emission drive element, and has a polarity capable of discharging charge remaining in wiring capacitance of the data line and a capacitance component of the display pixel; and

a gradation current supply circuit which supplies a gradation current having a signal polarity and magnitude corresponding to a gradation value of display data through the data line to the display pixel which is initialized by the reset circuit.

In order to achieve the above-described object, a display apparatus which displays image information, according to the invention, comprises:

a display panel with an array of a plurality of display pixels being arranged in the neighborhood of each of a plurality of intersections between a plurality of scanning lines and a plurality of data lines, wherein each display pixel includes a light-emitting element and a pixel drive circuit having a light-emission drive element having a current path connected to one end of the light-emitting element;

a reset circuit which initializes said each display pixel by applying a reset voltage to said each display pixel through said each data line, wherein the reset voltage has a voltage value that an absolute value of a potential difference applied between a control terminal of the light-emission drive element and one end of the current path connected to the one end of the light-emitting element being a larger value than an absolute value of a threshold voltage of the light-emission drive element, and has a polarity capable of discharging charge remaining in wiring capacitance of said each data line and a capacitance component of said each display pixel; and

a gradation current supply circuit which supplies a gradation current having a signal polarity and magnitude corresponding to a gradation value of display data through said each data line to the display pixel which is initialized by the reset circuit.

In order to achieve the above-described object, a drive control method according to the present invention for a display drive apparatus for driving a display pixel connected to a data line, the display pixel includes a light-emitting element and a pixel drive circuit including a light-emission drive element having a current path connected to one end of the light-emitting element, the method comprising the steps of:

applying a reset voltage to the display pixel through the data line thereby to initialize the display pixel, wherein the reset voltage has a voltage value that an absolute value of a potential difference applied between a control terminal of the light-emission drive element and one end of the current path connected to the one end of the light-emitting element being a larger value than an absolute value of a threshold voltage of the light-emission drive element, and has a polarity capable of discharging charge remaining in wiring capacitance of the data line and a capacitance component of the display pixel; and

supplying a gradation current having a signal polarity and magnitude corresponding to a gradation value of display data to the display pixel through the data line after the initialization by applying the reset voltage.

In order to achieve the above-described object, a drive control method according to the present invention for a display apparatus for displaying image information on a display panel with an array of a plurality of display pixels being arranged in the neighborhood of each of a plurality of intersections between a plurality of scanning lines and a plurality of data lines, wherein each display pixel includes a light-emitting element and a pixel drive circuit having a light-emission drive element having a current path connected to one of the light-emitting element, the method comprising the steps of:

initializing said each display pixel by applying a reset voltage to said each display pixel through said each data line, wherein the reset voltage has a voltage value that an absolute value of a potential difference applied between a control terminal of the light-emission drive element and one end of the current path connected to the one end of the light-emitting element being a larger value than an absolute value of a threshold voltage of the light-emission drive element, and has a polarity capable of discharging charge remaining in wiring capacitance of said each data line and a capacitance component of said each display pixel; and

supplying a gradation current having a signal polarity and magnitude corresponding to a gradation value of the display data through said each data line to said each display pixel after the initialization by applying the reset voltage.

### BRIEF DESCRIPTION OF THE SEVERAL VIEWS OF THE DRAWING

FIG. 1 is a block diagram schematically showing the general configuration of a display apparatus according to the invention;

FIG. 2 is a diagram showing the general configuration of the essential parts of a display apparatus according to an embodiment of the invention;

FIGS. 3A and 3B are block diagrams schematically showing an example of a data driver applicable to the display apparatus according to the embodiment;

FIGS. 4A and 4B are diagrams showing the general configuration of an example of a voltage-to-current conversion/current supply circuit applicable to the data driver according to the embodiment;

FIG. 5 is a diagram showing the circuit configuration of a specific example of a display pixel (pixel drive circuit, light-emitting element) applicable to a display apparatus according to the embodiment;

FIG. 6 is a timing chart showing the basic operation of the display pixel using the pixel drive circuit according to the embodiment;

FIGS. 7A and 7B are schematic diagrams showing the operation of the pixel drive circuit according to the embodiment;

FIG. 8 is a timing chart showing an example of a drive control method for a display apparatus according to the embodiment;

FIG. 9 is a characteristic diagram showing the relation between a gradation current (sink current) and a light-emission drive current of a display apparatus according to a comparative example for explaining the operational effects of the embodiment;

FIG. 10 is a characteristic diagram showing the relation between the gradation current (sink current, source current) and the light-emission drive current of the display apparatus according to the embodiment;

FIG. 11 is a characteristic diagram showing the relation between the voltage value applied to the data line and the display pixel and the write ratio (write current ratio) of the gradation current supplied to the display pixel in a voltage reset operation;

FIG. 12 is a characteristic diagram showing the relation between the presence or absence of switch setting of the signal polarity of the gradation current and the degree of degeneration of the light-emission drive current supplied to an organic EL element (the ratio of the light-emission drive current between initial state and degenerated state) in a current write operation; and

FIGS. 13A and 13B are timing charts showing the voltage change for the write operation in the display apparatus according to the embodiment.

### DETAILED DESCRIPTION OF THE INVENTION

A display drive apparatus, a drive control method thereof and a display apparatus having the display drive apparatus according to the invention will be explained in detail below with reference to an embodiment shown in the drawings.

<Display Apparatus>

First, the general configuration of the display apparatus according to the invention will be explained.

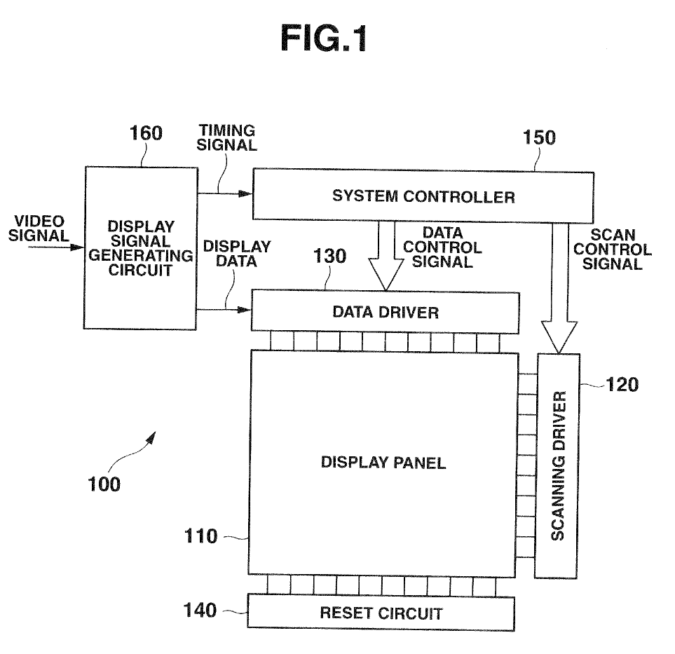

FIG. 1 is a block diagram schematically showing the general configuration of the display apparatus according to the invention.

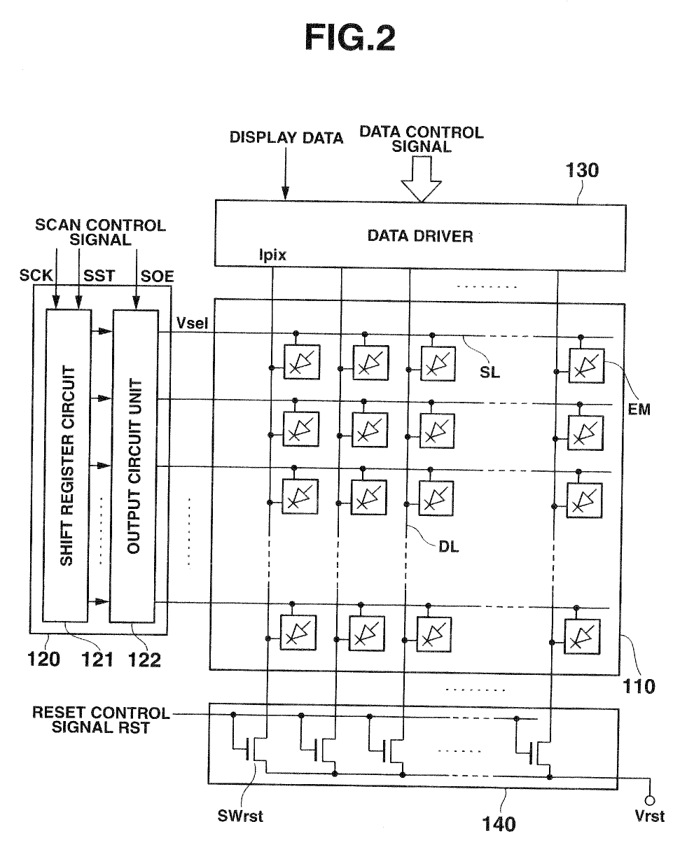

FIG. 2 is a diagram schematically showing the configuration of the essential parts of the display apparatus according to an embodiment of the invention.

As shown in FIGS. 1 and 2, a display apparatus 100 according to this embodiment generally includes:

a display panel 110 having a two-dimensional array (for example, a matrix array of n rows by m columns, where n and m are positive integers) of a plurality of display pixels EM each formed of a light-emitting element of current control type and a pixel drive circuit (corresponding to the drive circuit in the prior art described above) described later, for example, in the neighborhood of each intersection between a plurality of scanning lines SL and a plurality of data lines DL arranged orthogonally to each other;

a scanning driver (a scanning drive circuit, a select circuit) 120 connected to the scanning lines SL of the display panel 110 for setting the display pixels EM in select mode for each row by applying a scanning signal Vsel at a predetermined timing to each scanning line SL;

a data driver (signal drive circuit) 130 connected to the data lines DL of the display panel 110 for fetching the display data supplied from a display signal generating circuit 160 described later and supplying a gradation current Ipix corresponding to the particular display data to the data lines DL at a predetermined timing;

a reset circuit 140 connected to the data lines DL for applying a reset voltage Vrst to each display pixel EM through each data line DL at a predetermined timing before supplying the gradation current Ipix from the data driver 130;

a system controller (control circuit) 150 for generating and outputting a scan control signal and a data control signal for controlling each mode of operation of the scanning driver 120 and the data driver 130 based on the timing signal supplied from the display signal generating circuit 160 described later; and

the display signal generating circuit 160 for generating the display data (brightness gradation value) based on a video signal supplied from a source external to the display apparatus 100, for example, and supplying the data to the data driver 130 while at the same time extracting or generating a timing signal (system clock, etc.) for displaying the predetermined image information on the display panel 110 based on the display data and supplying the signal to the system controller 150.

Each part of the configuration described above will be explained specifically below.

(Display Panel)

The display panel 110 shown in FIG. 2 is selectively controlled to execute: a reset operation in which a predetermined reset voltage Vrst is applied to each data line DL from the reset circuit 140 based on the timing of applying the scanning signal Vsel to each scanning line SL from the scanning driver 120, as described later, and the charge held (remaining) in the parasitic wiring capacitance on each data line and the holding capacitance (the capacitor described later) of each display pixel is discharged for initialization; a current write operation in which a voltage component corresponding to the gradation current Ipix supplied from the data driver 130 to each data line DL is held (written) in the holding capacitance of each display pixel; and a light-emitting operation in which a light-emission drive current based on the voltage component is supplied to the light-emitting element to emit light at a predetermined brightness gradation.

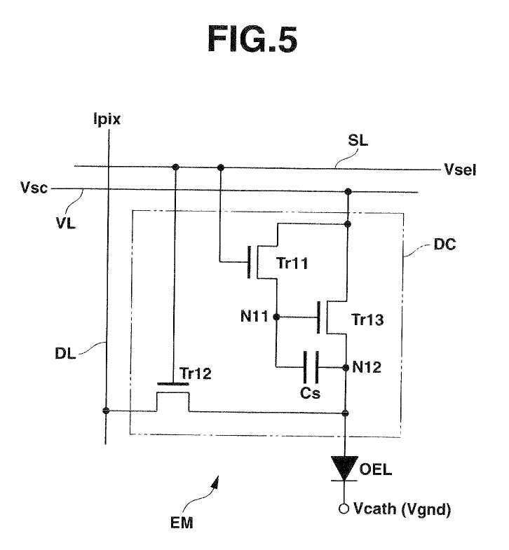

The display pixels EM (described later with reference to FIG. 5) according to this embodiment are each controlled to assume either a select mode (select period) set upon application thereto of the scanning signal Vsel of select level (high level, for example) in which the gradation current Ipix is supplied and the display data is written (as a current write operation) while at the same time suspending the supply of the light-emission drive current to the light-emitting elements into a no-light-emission state, or a non-select mode (non-select period) set upon application thereto of the scanning signal Vsel of non-select level (for example, low level) in which the light-emission drive current based on the gradation current Ipix written by the current write operation is supplied to the light-emitting element into a light-emission state to emit light at a predetermined brightness gradation. By the way, a specific circuit example and the circuit operation of the display pixels EM (pixel drive circuit) used with the display panel according to this embodiment will be described in detail later.

(Scanning Driver)

The scanning driver 120 is controlled in such a manner that the scanning signal Vsel of select level (for example, high level) is applied sequentially to the scanning lines SL based on the scan control signal supplied from the system controller 150 thereby to set the display pixels EM on each row in select mode, and during this period (select period), the gradation current Ipix based on the display data supplied through each data line DL by the data driver 130 is written in each display pixel EM.

The scanning driver 120, as shown in FIG. 2, for example, is configured of a shift register circuit 121 for sequentially outputting a shift signal corresponding to the scanning line SL on each row based on a scanning start signal SST and a scanning clock signal SCK supplied as a scan control signal from the system controller 150 described later, and an output circuit unit 122 for converting the shift signal output from the shift register circuit 121 to a predetermined signal level (high level) and outputting the scanning signal Vsel to each scanning line SL based on an output control signal SOE supplied as a scan control signal from the system controller 150.

(Data Driver 130)

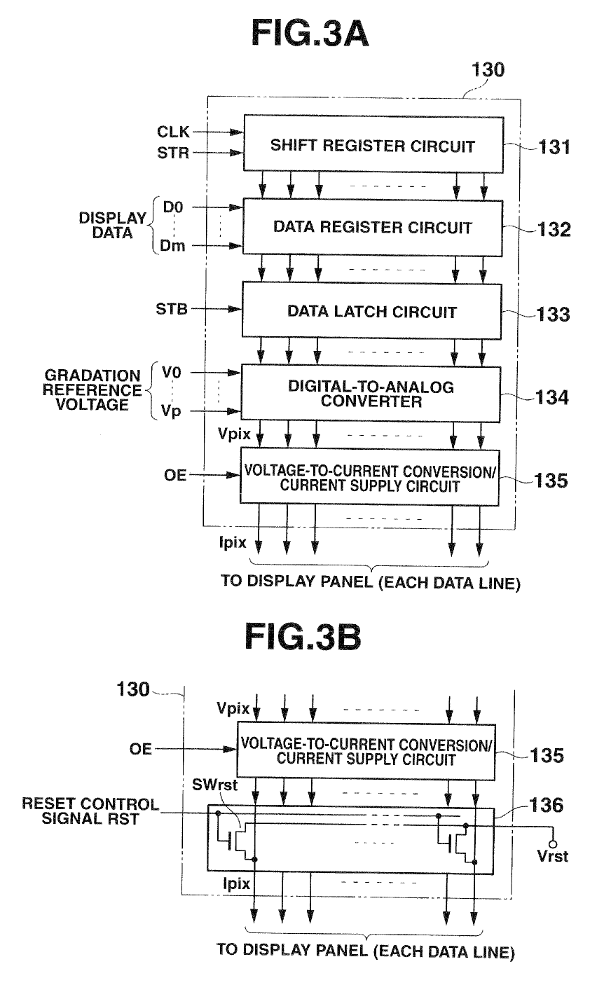

FIGS. 3A and 3B are block diagrams schematically showing an example of the configuration of the data driver applicable to the display apparatus according to this embodiment.

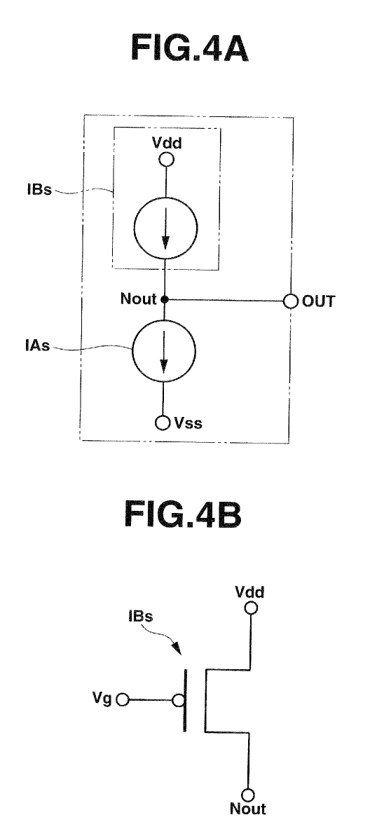

FIGS. 4A and 4B are diagrams showing a general configuration of an example of a voltage-to-current conversion/current supply circuit applicable to the data driver according to this embodiment.

The data driver 130 operates in such a manner that the display data for each row including the digital signal supplied from the display signal generating circuit 160 described later are sequentially fetched and held at a predetermined timing based on the data control signal supplied from the system controller 150, and the gradation current Ipix corresponding to the brightness gradation of the particular display data is generated and supplied en masse to each data line DL within the select period set for each scanning line SL.

The data driver 130, as shown in FIG. 3A, for example, includes a shift register circuit 131 for sequentially outputting a shift signal based on the data control signal (shift clock signal CLK, sampling start signal STR) supplied from the system controller 150, a data register circuit 132 for sequentially fetching display data D0 to Dm for each row supplied from the display signal generating circuit 160 based on the input timing of the shift signal, a data latch circuit 133 for holding the display data D0 to Dm for each row fetched by the data register circuit 132 based on the data control signal (data latch signal STB), a digital-to-analog converter 134 for converting the display data D0 to Dm thus held to a predetermined analog signal voltage (gradation voltage Vpix) based on the gradation reference voltages V0 to Vp supplied from a power supply circuit (not shown), and a voltage-to-current conversion/current supply circuit 135 for generating the gradation current Ipix corresponding to the display data converted to the analog signal voltage and outputting the gradation current Ipix en masse to each display pixel EM through each data line DL at a timing based on the data control signal (output enable signal OE) supplied from the system controller 150.

Especially, the voltage-to-current conversion/current supply circuit 135 according to this embodiment, as shown in FIG. 4A, for example, includes a data current source IAs with an end thereof connected to an output terminal OUT (output contact Nout) and a second end thereof connected to a low-voltage source Vss for supplying a data current corresponding to the display data converted to an analog signal voltage (gradation voltage Vpix) by the digital-to-analog converter 134 and an offset current source IBs with an end thereof connected to a high-voltage source Vdd and a second end thereof connected to the output terminal OUT (output contact Nout) for supplying a predetermined offset current.

The data current source IAs is set to supply the data current from the output terminal OUT (output contact Nout) toward the low-voltage source Vss, while the offset current source IBs is set to supply the same current from the high-voltage source Vdd toward the output terminal OUT (output contact Nout).

The offset current source IBs, as shown in FIG. 4B, for example, may be a p-channel field-effect transistor (FET) with one end of the current path (source-drain circuit) thereof connected to the high-voltage source Vdd and the other end of the current path thereof connected to the output terminal OUT (output contact Nout). The output terminal OUT (output contact Nout) is connected to the data line DL through a switch circuit (such as a transistor switch, not shown) adapted to turn on/off based on the data control signal (output enable signal OE) supplied from the system controller 150.

In the presence of the voltage-to-current conversion/current supply circuit 135 available for each data line DL, a predetermined offset current generated by the offset current source IBs is subtracted from the data current generated by the data current source IAs in accordance with the gradation voltage Vpix set in correspondence with the brightness gradation of the display data, so that the offset current increases beyond the data current in accordance with the brightness gradation (gradation voltage) of the display data thereby to generate the positive gradation current Ipix which forcibly flows (is forced to flow) toward the data line DL from the output terminal OUT in the low gradation area (as a current source system described later).

In the middle and high gradation areas, on the other hand, the data current increases beyond the offset current, so that a negative gradation current Ipix is generated which is drawn (attracted) to flow from the data line DL toward the output terminal OUT (as a current sink system described later).

Specifically, the gradation current Ipix supplied to the data line DL is switched and made negative or positive in accordance with the brightness gradation value contained in the display data written in the display pixel EM.

(Reset Circuit 140)

The reset circuit 140 performs the control operation in such a manner that the reset voltage Vrst is applied to the display pixel EM set in select mode through each data line DL at a predetermined timing before the timing (current write operation) of supplying the gradation current Ipix based on the display data to each data line DL from the data driver 130 based on the reset control signal RST, so that the charge remaining in the parasitic wiring capacitance on the data lines DL and the charge accumulated in the holding capacitance (the capacitor described later) included in each display pixel EM are discharged to set (initialize) the apparatus in the initial state.

The reset circuit 140 is applicable as a configuration including a plurality of switching elements each having an end thereof connected to the voltage source of the reset voltage Vrst for each data line DL arranged on the display panel 110 and adapted to turn on/off en masse based on the reset control signal RST thereby to apply the reset voltage Vrst to each data line DL. Specifically, as shown in FIG. 2, the reset circuit 140 is suitably configured of a plurality of transistor switches SWrst each having one end of the current path (source-drain circuit) thereof applied with a shared reset voltage Vrst, the other end of the current path thereof connected to each data line DL, and a control terminal (gate) supplied with a shared reset control signal RST.

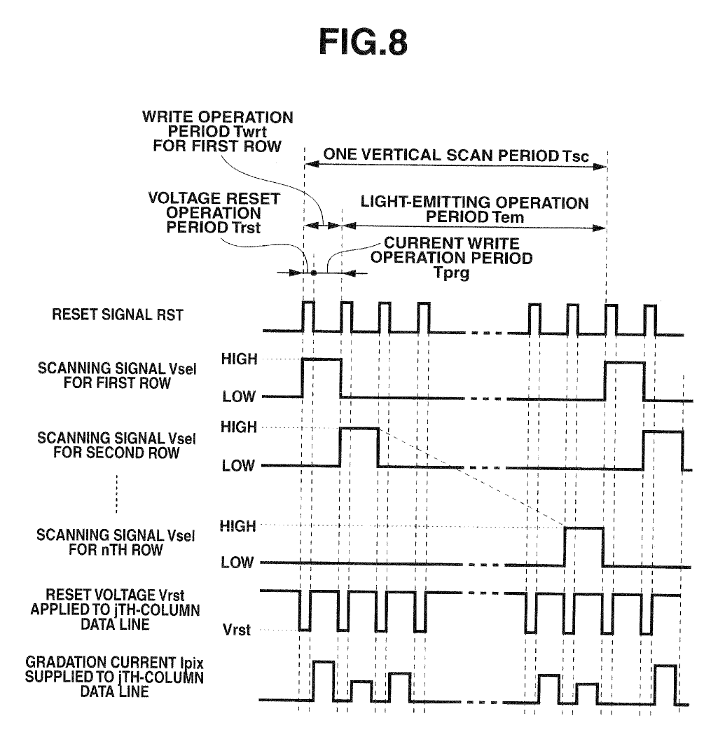

In the reset operation performed by the reset control signal RST, as described later (FIG. 8), the reset voltage Vrst is applied through each data line DL before the timing (current write operation) of supplying the gradation current Ipix corresponding to the display data during the write operation period of the display pixels EM on each row thereby to discharge the charge remaining in the wiring capacitance of the data line DL and the charge accumulated in the holding capacitance (capacitor) of the display pixels EM on the row set in select mode. The reset control signal RST for controlling the discharge of the accumulated charge by applying the reset voltage Vrst to each display pixel EM through each data line DL, therefore, has a timing related to the timing of application of the scanning signal Vsel. Therefore, the reset control signal RST may be generated and output by the scanning driver 120 based on the scan control signal, or generated by the system controller 150 and output directly to the reset circuit 140.

Also, the reset voltage Vrst is relatively low to such an extent as to be capable of satisfactorily discharging the charge remaining in the wiring capacitance of each data line DL and the charge accumulated in the holding capacitance of each display pixel EM. According to this embodiment, in the case where the reset voltage Vrst is lower than the cathode voltage of the light-emitting element (for example, the organic EL element) arranged in each display pixel EM, i.e., in the case where the voltage at the cathode is equal to the ground voltage (zero), then the reset voltage Vrst is set to a negative voltage (for example, −5 V with an absolute value of 5) lower than the ground voltage and higher in absolute value than zero, as described in more detail later.

This embodiment has been described above with reference to a case in which as shown in FIG. 2, the reset circuit 140 is configured separately from the data driver 130. As shown in FIG. 3B, however, a reset circuit 136 having a circuit configuration equivalent to that of FIG. 2 may be arranged in the output stage of the data driver 130 (the last stage of the voltage-to-current conversion/current supply circuit 135) shown in FIG. 3A, for example, and these component parts may be configured as a single data driver 130 (in which case, the reset circuit 140 shown in FIG. 2 is eliminated) and built in a single driver chip. As another alternative, the reset circuit 140 may be formed integrally with the display pixels EM and the various wires on the panel board of the display panel 110.

(System Controller 150)

The system controller 150 performs the control operation in such a manner that the scan control signal and the data control signal for controlling the operation are output to the scanning driver 120 and the data driver 130 described above thereby to activate each driver at a predetermined timing, the scanning signal Vsel and the gradation current Ipix are thus generated and output to the display panel 110, and the display data generated by the display signal generating circuit 160 is written in each display pixel EM for the light-emitting operation thereby to display the predetermined image information.

(Display Signal Generating Circuit 160)

The display signal generating circuit 160 extracts a brightness gradation signal component, for example, from the video signal supplied from a source external to the display apparatus 100 and supplies the display data (brightness gradation value) to the data driver 130 for each row of the display panel 110. In the case where the video signal contains a timing signal component specifying the display timing of the image information such as the TV broadcast signal (composite video signal), the display signal generating circuit 160 may be equipped with both the function of extracting the brightness gradation signal component and the function of extracting and supplying the timing signal component to the system controller 150. In this case, the scan control signal and the data control signal supplied to the scanning driver 120 and the data driver 130 are generated by the system controller 150 based on the timing signal supplied from the display signal generating circuit 160.

<Specific Example of Display Pixel>

Next, a specific example of the circuit of each of the display pixels arranged on the display panel will be explained with reference to the related drawings.

FIG. 5 is a diagram showing the circuit configuration of a specific example of the display pixel (pixel drive circuit, light-emitting element) applicable to the display apparatus according to this embodiment.

As shown in FIG. 5, the display pixel EM according to this embodiment generally includes a pixel drive circuit DC for setting the display pixel EM in select mode based on the scanning signal Vsel applied from the scanning driver 120 described above, fetching and holding, as a voltage component, the gradation current Ipix supplied from the data driver 130 in select mode and supplying the light-emission drive current corresponding to the gradation current Ipix to the light-emitting elements, and a light-emitting element of current control type such as an organic EL element OLED for emitting light at a predetermined brightness gradation based on the light-emission drive current supplied from the pixel drive circuit DC.

The pixel drive circuit DC, as shown in FIG. 5, for example, specifically has a configuration including a transistor Tr11 with a gate terminal connected to the scanning line SL, a drain terminal connected to the source voltage line VL (source voltage Vsc) and a source terminal connected to a contact point N11, a transistor Tr12 with a gate terminal connected to the scanning line SL, a source terminal connected to the data line DL and a drain terminal connected to a contact point N12, a transistor (light-emission drive element) Tr13 with a gate terminal connected to the contact point N11, a drain terminal connected to the source voltage line VL and a source terminal connected to the contact point N12, and a capacitor (holding capacitance) Cs connected between the contact point N11 and the contact point 12 (between the gate and source of the transistor Tr13).

The transistors Tr11 to Tr13 used in the pixel drive circuit DC according to this embodiment are not specifically limited. By configuring the pixel drive circuit DC entirely of the n-channel field-effect transistors (thin-film transistors), for example, n-channel amorphous silicon thin-film transistors can be employed. In this case, the pixel drive circuit DC having stable operation characteristics (electron mobility, etc.) can be fabricated with a comparatively simple process by use of the amorphous silicon fabrication technique which is already established. Also, the capacitor Cs may be a parasitic capacitance formed between gate and source of the transistor Tr13, or a capacitor may be connected between the gate and source of the transistor Tr13 in addition to the parasitic capacitance.

The organic EL element OLED has the anode thereof connected to the contact point N11 of the pixel drive circuit DC and the cathode thereof to a reference voltage Vcath (for example, ground voltage Vgnd) at a predetermined low potential.

Also, the source voltage Vsc applied to the source voltage line VL is lower or higher in potential than the reference voltage Vcath in accordance with whether the display pixel EM is in select or non-select mode (strictly, in the current write operation or the light-emitting operation), as described in more detail below as a basic operation.

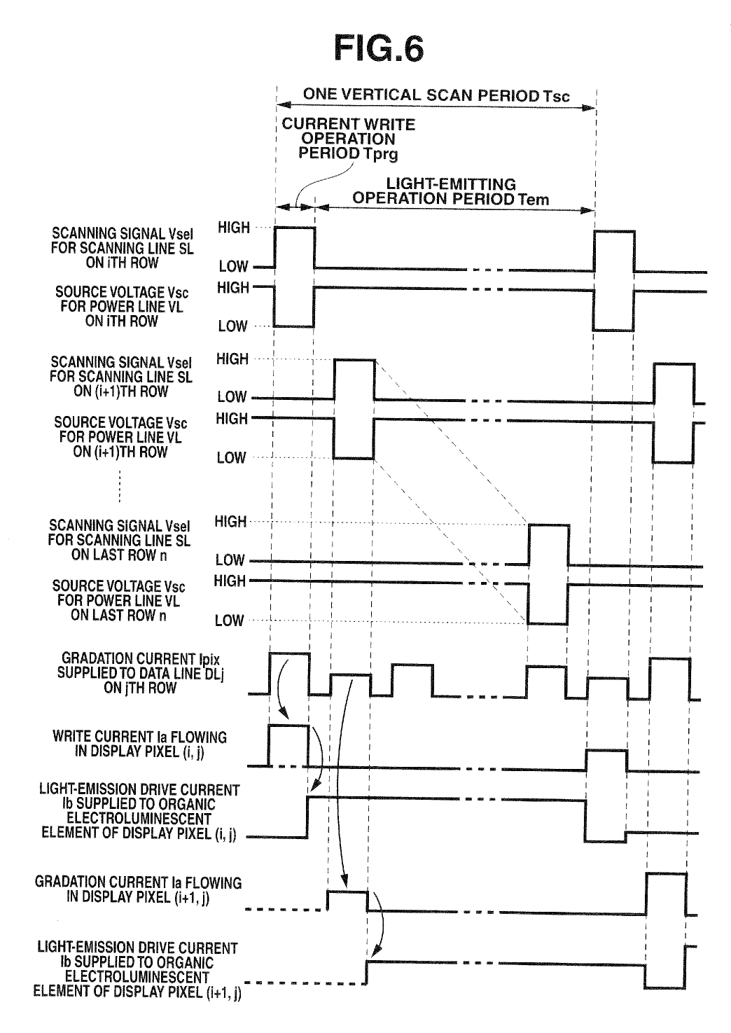

FIG. 6 is a timing chart showing the basic operation of each display pixel using the pixel drive circuit according to this embodiment.

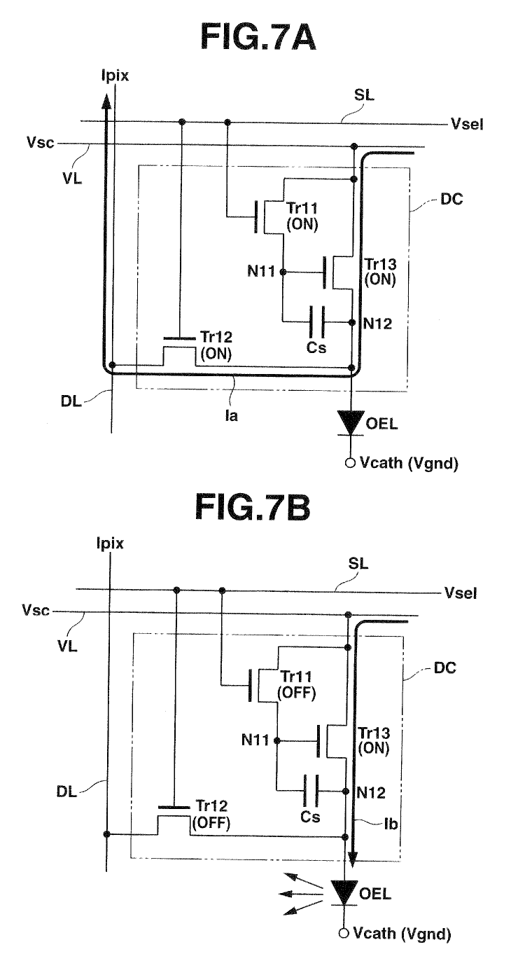

FIGS. 7A and 7B are schematic diagrams showing the operation of the pixel drive circuit according to this embodiment.

With reference to FIG. 6, an explanation will be made about the display pixel EM located on row i and column j in the two-dimensional array (matrix array having n rows and m columns) of the display pixels EM on the display panel 110.

In the pixel drive circuit DC described above, the light emission of the light-emitting element (organic EL element OLED) is driven and controlled, with one vertical scan period Tsc as one cycle as shown in FIG. 6, for example, in such a manner that the particular one vertical scan period Tsc contains a current write operation period Tprg in which a display pixel EM connected to the scanning line SL is selected and the gradation current Ipix corresponding to the display data is written and held as a voltage component on the one hand, and a light-emitting operation period (non-select period) Tem in which the light-emission drive current corresponding to the display data is supplied to the organic EL element OLED and the light-emitting operation is performed at a predetermined brightness gradation based on the voltage component written and held during the current write operation period Tprg on the other hand (Tsc≧Tprg+Tem). The current write operation periods Tprg are set for the respective scanning lines SL connected with the display pixels EM on each row in a manner not to be temporally overlapped with each other.

According to this embodiment, as described later (FIG. 8), a voltage reset operation for applying a predetermined reset voltage Vrst to the display pixel EM through each data line DL is executed (voltage reset operation period Trst) and then the current write operation for writing the gradation current Ipix (current write operation period Tprg) is executed within the write operation period (select period) Twrt during which the display pixels EM on each row are set in select mode. Therefore, the current write operation (current programming operation) is executed within a shorter time than the write operation period Twrt described later.

(Current Write Operation Period)

During the current write operation period Tprg of the display pixel EM, as shown in FIG. 6, a high-level scanning signal Vsel is applied to a specified scanning line SL from the scanning driver 120 first of all, and the display pixels EM on the particular row are set in select mode, while at the same time applying a low-level source voltage (≦reference voltage Vcath) to the source voltage line VL of the display pixels EM on the same row. Also, in synchronism with this timing, a gradation current Ipix corresponding to the display data for the row is supplied to each data line DL from the data driver 130.

According to this embodiment, as described later, the gradation current Ipix supplied to each data line DL is made negative or positive in accordance with the brightness gradation value contained in the display data written in each display pixel. The gradation current Ipix, if negative, is drawn (attracted) to flow toward the data driver 130 from the display pixel EM through the data lines DL, while the gradation current Ipix, if positive, on the other hand, is forced (forcibly made to flow) in the direction toward the display pixel EM from the data driver 130 through the data lines DL.

The description that follows deals with a case in which the gradation current Ipix is made negative and drawn to flow from the display pixel EM toward the data driver 130 through the data lines DL as a basic operation of the display pixel EM.

Upon application of a high-level scanning signal Vsel thereto, the transistors Tr11 and Tr12 of the pixel drive circuit DC are turned on, and the low-level source voltage Vsc is applied to the contact point N11 (i.e., the gate terminal of the transistor Tr13 and one end of the capacitor Cs). At the same time, the gradation current Ipix is drawn to flow toward the data line DL, and therefore, a voltage lower in potential than the low-level source voltage Vsc is applied to the contact point N12 (i.e., the other end of the capacitor Cs and the source terminal of the transistor Tr13).

As described above, with the generation of a potential difference between the contact points N11 and N12 (between gate and source of the transistor Tr13), the transistor Tr13 is turned on, and as shown in FIG. 7A, a write current Ia corresponding to the gradation current Ipix flows to the data driver 130 from the source voltage line VL through the transistor Tr13, the contact point N12, the transistor Tr12 and the data line DL.

In the process, the charge corresponding to the potential difference generated between the contact points N11 and M12 (between gate and source of the transistor Tr13) by the flow of the write current Ia is accumulated and held as a voltage component (charged) in the capacitor Cs. Also, the source voltage Vsc having a voltage level not higher than the low-level reference voltage Vcath (ground voltage Vgnd) is applied to the source voltage line VL. Further, in view of the fact that the write current Ia is controlled to flow from the contact point N12 toward the data line DL, the potential applied to the anode (contact point N12) of the organic EL element OLED becomes lower than the potential (reference voltage Vcath) of the cathode, so that no current flows in the organic EL element OLED and the light-emitting operation is not performed.

(Light-Emitting Operation Period)

Next, during the light-emitting operation period Tem after the current write operation period Tprg, as shown in FIG. 6, a low-level scanning signal Vsel is applied to a specified scanning line SL from the scanning driver 120 and the display pixels EM on the same row are set in non-select mode, while at the same time applying a high-level source voltage Vsc (>reference voltage Vcath) to the source voltage line VL of the display pixels EM on the same row. Also, in synchronism with this timing, the operation of the data driver 130 to draw in the gradation current Ipix is stopped.

As a result, the transistors Tr11 and Tr12 of the pixel drive circuit DC turn off, and the application of the source voltage Vsc to the contact point N11 (i.e., the gate terminal of the transistor Tr13 and the one end of the capacitor Cs) is shut off, while at the same time shutting off the application of the voltage level attributable to the operation of the data driver 130 to draw the gradation current Ipix to the contact point N12 (i.e., the source terminal of the transistor Tr13 and the other end of the capacitor Cs). Thus, the capacitor Cs holds the charge accumulated during the current write operation period Tprg described above.

In view of the fact that the capacitor Cs holds the voltage charged during the current write operation as described above, the potential difference is held between the contact points N11 and N12 (between gate and source of the transistor Tr13), and the transistor Tr13 is kept on. Also, in view of the fact that the source voltage Vsc higher in voltage level than the reference voltage Vcath is applied to the source voltage line VL, the potential applied to the anode (contact point N12) of the organic EL element OLED becomes higher than the potential (reference voltage Vcath) at the cathode thereof.

As shown in FIG. 7B, therefore, a predetermined light-emission drive current Ib flows in the organic EL element OLED along the forward bias direction from the source voltage line VL through the transistor Tr13 and the contact point N12, and the organic EL element OLED emits light. The potential difference (charge voltage) based on the charge accumulated in the capacitor Cs corresponds to the potential difference generated in the case where the write current Ia corresponding to the gradation current Ipix flows in the transistor Tr13. Therefore, the light-emission drive current Ib supplied to the organic EL element OLED is substantially equal to the write current Ia. During the light-emitting operation period Tem after the current write operation period Tprg, therefore, the light-emission drive current Ib is continuously supplied through the transistor Tr13 based on the voltage component corresponding to the display data (gradation current Ipix) written during the current write operation period Tprg. Thus, the organic EL element OLED continues to emit light at a brightness gradation corresponding to the display data.

The series of operation described above is sequentially repeated for all the scanning lines SL making up the display panel 110, with the result that the display data for one screen of the display panel are written and light is emitted at the predetermined brightness gradation thereby to display the desired image information.

Incidentally, the configuration for applying the predetermined source voltage Vsc to the source voltage line VL in the pixel drive circuit DC according to this embodiment includes, in addition to the configuration of the display apparatus 100 shown in FIG. 1, a configuration having a power driver connected to a plurality of the source voltage lines VL arranged in parallel to the scanning lines SL of the display panel 110, in which the source voltage Vsc having a predetermined voltage value is applied from the power driver to the source voltage line VL for the row (the display pixels EM set in select mode) supplied with the scanning signal Vsel by the scanning driver 120 at a timing (FIG. 6) synchronized with the scanning signal Vsel output from the scanning driver 120 based on the power control signal supplied from the system controller 150.

Although the display pixel EM described above is shown as a circuit configuration having the three transistors Tr11 to Tr13 as a pixel drive circuit DC, the invention is not limited to this configuration of the embodiment, and as an alternative, a circuit configuration having more than three transistors may be employed with equal effect. Also, in place of the configuration having an organic EL element as a light-emitting element, the invention is not limited to such a configuration, and may alternatively include other light-emitting elements of current control types such as the light-emitting diode.

<Drive Control Method for Display Apparatus>

Next, the drive control method for the display apparatus according to this embodiment will be explained.

FIG. 8 is a timing chart showing an example of the drive control method for the display apparatus according to this embodiment.

The drive control method for the display apparatus 100 having the configuration described above assumes one vertical scan period Tsc as one cycle, as shown in FIG. 8, for example, which is set to include a voltage reset operation period Trst in which the display pixels EM for each row are set in select mode and the charge remaining in the parasitic wiring capacitance on the data lines DL and the charge accumulated in the capacitor (holding capacitance) Cs arranged in the display pixel EM are discharged into an initialized state (voltage reset operation period Trst), a write operation period (select period) Twrt for carrying out the current write operation (current programming operation, current write operation period Tprg) to charge a predetermined voltage component in the capacitor Cs of each display pixel EM by supplying the gradation current Ipix having a signal polarity and magnitude corresponding to the display data after the reset operation, and a light-emitting operation period (non-select period) Tem in which the organic EL element OLED is caused to emit light at a brightness gradation corresponding to the display data by setting the display pixels EM for each row in non-select mode after the write operation period Twrt and generating the light-emission drive current Ib based on the voltage component charged in the capacitor Cs (Tsc≧Twrt+Tem=Trst+Tprg+Tem).

This series of the drive operation is sequentially repeated for each row and at the same time, the write operation period Twrt (the voltage reset operation period Trst and the current write operation period Tprg) constituting the select period for each row is set not to temporally overlap with the current write operation periods for other rows.

Specifically, in the drive control method according to this embodiment, the current write operation (current write operation period Tprg) in the basic operation (FIG. 6) of the display pixel EM is executed within the write operation period Twrt described above, and the voltage reset operation (voltage reset operation period Trst) is executed at a timing in advance of the current write operation within the write operation period Twrt.

Each operation will be specifically explained below.

(Voltage Reset Operation)

First, during the voltage reset operation period Trst, as shown in FIG. 8, a low-level source voltage Vsc (≦reference voltage Vcath) is applied to the source voltage line VL, and the high-level scanning signal Vsel is sequentially applied from the scanning driver 120 to each scanning line SL thereby to set the display pixels EM of each row in select mode, after or immediately after which a high-level reset control signal RST is supplied from, for example, the system controller 150 to the reset circuit 140 thereby to execute the voltage reset operation.

As a result, the transistors Tr11 and Tr12 included in the pixel drive circuit DC (FIG. 5) making up each display pixel EM are turned on, while at the same time turning on each transistor switch SWrst of the reset circuit 140. Thus, the reset voltage Vrst (for example, −5 V) lower in potential than the reference voltage Vcath (for example, zero) on the cathode side of the organic EL element OLED is applied from the reset circuit (transistor switch SWrst) to the second end (contact point N12) of the capacitor Cs of the pixel drive circuit DC through the data line DL, so that the charge remaining in the wiring capacitance of each data line DL and the charge accumulated in the capacitor Cs of each display pixel EM are discharged into an initialized state. In the process, the transistor Tr11 is on, and therefore, the gate terminal (control terminal) and the drain terminal of the transistor (light-emission drive element) Tr13 are shorted, so that the drain-source voltage of the transistor Tr13 is equal to the gate-source voltage thereof. Through the data line DL, therefore, the reset voltage Vrst is applied between the drain and the source of the transistor Tr13 on the one hand and between the gate and the source of the transistor Tr13 at the same time.

(Current Write Operation)

Next, during the current write operation period Tprg after the voltage reset operation period Trst, as shown in FIG. 8 and described above in the basic operation (FIGS. 6 and 7) of the pixel drive circuit DC, the high-level scanning signal Vsel is kept applied to each scanning line SL from the scanning driver 120, and while the display pixels EM on each row are held in select mode, the low-level source voltage Vsc is applied to the source voltage line VL. At the same time, the gradation current Ipix having a signal polarity and magnitude corresponding to the display data is supplied to each display pixel EM from the data driver 130 through each data line DL thereby to hold (charge) the voltage component based on the gradation current Ipix (≈write current Is) in the capacitor Cs of the pixel drive circuit DC.

According to this embodiment, the gradation current Ipix supplied to each display pixel EM from the data driver 130 through each data line DL, as described above, is made positive or negative in accordance with the brightness gradation value of the display data. As described in more detail later, in the low gradation area of the display data (brightness gradation value), the gradation current Ipix is made positive by the data driver 130, so that the gradation current Ipix is supplied, as if “poured”, to flow into the display pixels EM set in select mode from the data driver 130 through the data line DL (hereinafter referred to as “the current source system”, the associated gradation current Ipix being “the source current”). In the middle and high gradation areas of the display data (brightness gradation value), on the other hand, the gradation current Ipix is made negative by the data driver 130, so that the gradation current Ipix is supplied, as if drawn, to the data driver 130 through the data line DL from the display pixels EM set in select mode (hereinafter referred to as “the current sink system”, the associated gradation current Ipix being “the sink current”).

(Light-Emitting Operation)

During the light-emitting operation period Tem after the current write operation period Tprg (i.e., after the write operation period Twrt), as shown in FIG. 8 and described in the basic operation (FIGS. 6 and 7) of the pixel drive circuit DC, the low-level scanning signal Vsel is applied from the scanning driver 120 to each scanning line SL for which the current write operation period Tprg is ended thereby to set the display pixel EM in non-select mode. At the same time, the high-level source voltage Vsc is applied to the source voltage line VL, so that the light-emission drive current Ib based on the voltage component held in the capacitor Cs is supplied to the organic EL element OLED thereby to execute the light-emitting operation at a brightness gradation corresponding to the display data.

<Verification of Operational Effects>

The operational effects of the display drive apparatus, the display apparatus and the drive control method thereof described above are verified in detail below.

Before explaining the operational effects of this embodiment, the operation characteristics of a comparative example of the display apparatus according to this embodiment (hereinafter referred to as “the comparative object”) are verified.

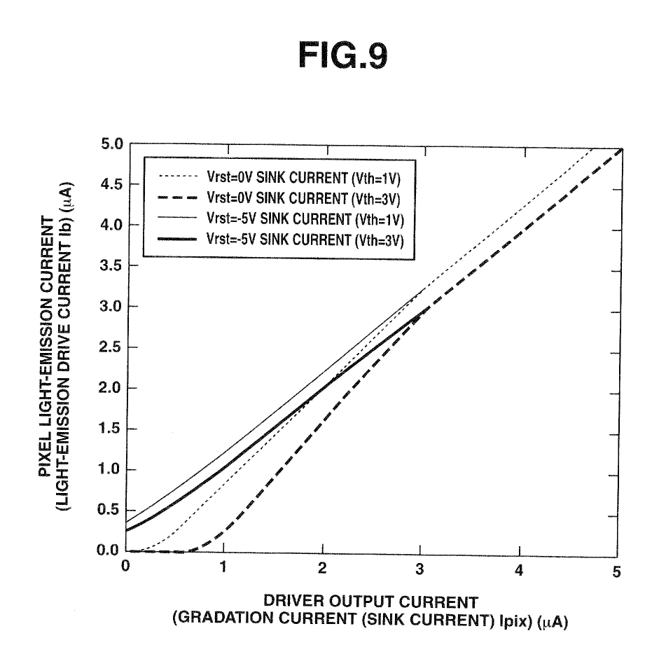

FIG. 9 is a characteristic diagram showing the relation between the gradation current (sink current) and the light-emission drive current of the display apparatus of the comparative object for explaining the operational effects of this embodiment.

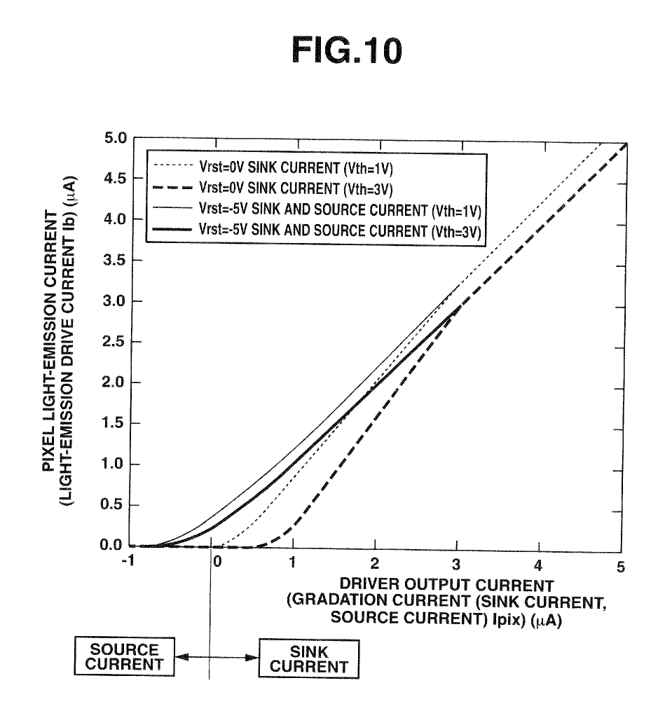

FIG. 10 is a characteristic diagram showing the relation between the gradation current (sink current, source current) and the light-emission drive current of the display apparatus according to this embodiment.

In FIGS. 9 and 10, the result of a simulation test is shown assuming that the voltage reset operation period Trst is 10 μsec, the current write operation period Tprg is 55 μsec and a negative voltage (−5 V) and 0 V are applied as a reset voltage Vrst.

In the description that follows, assume that the potential of the source voltage line VL is zero during the voltage reset operation.

As described above, the display apparatus according to this embodiment is controlled in such a manner that the charge remaining in the wiring capacitance of each data line DL and the charge held in the capacitor Cs of each display pixel EM (pixel drive circuit DC) are discharged by applying a predetermined reset voltage Vrst to the particular data line DL thereby to carry out the reset operation (initialize operation), followed by the write operation in which the gradation current Ipix having a signal polarity and magnitude corresponding to the display data is supplied to each data line DL thereby to hold the voltage component corresponding to the gradation current Ipix in the capacitor Cs of each display pixel EM.

In a comparative example (comparative object) of this embodiment, assume that the write operation of the display apparatus according to this embodiment is operated in such a manner that the voltage component corresponding to the gradation current Ipix is held (written) in each display pixel EM by use of only the current sink system in which only a negative current is supplied to each display pixel EM through the data line DL as the gradation current Ipix corresponding to the display data (brightness gradation value) and the write current Ia (sink current) corresponding to the particular gradation current Ipix is drawn into the data driver 130 from the display pixel EM through the data line DL.

Referring to a case where the display data is written using only the current sink system, the relation is verified between the gradation current (specifically, the sink current drawn into the data driver 130) Ipix supplied from the data driver 130 and the light-emission drive current Ib flowing from the pixel drive circuit DC of each display pixel EM to the organic EL element OLED. As shown in FIG. 9, in the middle and high gradation areas having a comparatively large gradation current Ipix, the light-emission drive current (current for pixel light emission) Ib supplied from the pixel drive circuit DC to the organic EL element OLED tends to increase substantially linearly in accordance with the gradation current (sink current) Ipix supplied from the data driver 130 to the data line DL.

The relation between the gradation current Ipix and the light-emission drive current Ib is verified in detail. Assume that the reset voltage Vrst is set to zero (i.e., the same potential as the source voltage line VL) as generally used in the voltage reset operation. In the case where the gradation current Ipix is set to zero as shown by the thin dotted line (Vrst=0, sink current [Vth=1 V]) in FIG. 9, the light-emission drive current Ib can be set to zero. In the low gradation area where the gradation current Ipix assumes a minuscule value (specifically, approximately zero), however, the light-emission drive current Ib is approximately zero and the linearity of the light-emission drive current Ib with respect to the gradation current Ipix is lost, thereby posing the problem that the voltage component corresponding to the gradation current Ipix cannot be sufficiently held during the current write operation period Tprg (=55 μsec) set as a simulation test condition. This is because the gradation current Ipix supplied from the data driver 130 through the data line DL is used to charge the capacitor Cs until a charge voltage of the capacitor Cs reaches the threshold voltage Vth of the transistor Tr13, and after that, a part of the gradation current Ipix is used to charge the capacitor Cs, so that a current flowing in the current path of transistor Tr13 becomes smaller than the gradation current Ipix.

Also, in the case where the threshold voltage Vth of the transistor Tr13 included in the pixel drive circuit DC of each display pixel EM for light-emission drive to supply the light-emission drive current Ib to the organic EL element OLED undergoes a change (Vth shift) (for example, in the case where the threshold voltage Vth changes from 1 to 3 V), as shown by a thin dotted line (Vrst=0, sink current [Vth=1 V]) and a thick dotted line (Vrst=0, sink current [Vth=3 V]) in FIG. 9, the light-emission drive current Ib in the low gradation area undergoes a conspicuous change, thereby posing the problem that the brightness change of the organic EL element OLED Increases to such an extent that the light emission at the proper brightness gradation corresponding to the display data becomes impossible.

In the case where the reset voltage Vrst is set to a absolute value greater than zero, or preferably, to a value (for example, −5 V with the absolute value 5 V of the potential difference with the potential of the source voltage line VL) at which the potential difference (equal to the absolute gate-source voltage of the transistor Tr13) between the source voltage line VL and the contact point N12 (the drain-source voltage of the transistor Tr13) is larger than the absolute threshold voltage Vth of the transistor Tr13, then, as shown by the thin solid line (Vrst=−5 V, sink current [Vth=1 V]) and the thick solid line (Vrst=−5 V, sink current [Vth=3 V]) in FIG. 9, the characteristic of the light-emission drive current Ib with respect to the gradation current (sink current) Ipix assumes a satisfactory linearity as in the case where the reset voltage Vrst is set to 0 V in the middle and high gradation areas comparatively large in gradation current Ipix. In this case, because the capacitor Cs is already charged after the reset voltage Vrst has been applied, a small part of the gradation current Ipix is used to charge the capacitor Cs in the low gradation area, and influence of change of the threshold voltage Vth of the transistor Tr13 is suppressed. However, because the charge voltage of the capacitor Cs after the reset voltage has been applied is higher than the threshold voltage Vth of the transistor Tr13, even in the case where the gradation current Ipix is set to zero, the light-emission drive current Ib cannot be set to absolute zero and a minuscule current undesirably would flow in the organic EL element OLED. In this case, the black display level providing a reference of the brightness gradation would “rise” (change to a brighter side) and the contrast ratio would be reduced, thereby leading to the problem of an extremely degraded display quality.

In view of this, according to the invention, as described in the embodiments above, the reset voltage Vrst with the absolute value thereof larger than 0 V is applied to the data line DL thereby to discharge the charge remaining in the wiring capacitance of the particular data line DL and the charge held in the capacitor Cs arranged in the display pixel EM (pixel drive circuit DC) as a voltage reset operation, after which the gradation current Ipix having a signal polarity (positive or negative) and magnitude corresponding to the display data is supplied to the display pixel EM through each data line DL as a current write operation for holding the voltage component corresponding to the particular gradation current Ipix in the capacitor Cs of each display pixel EM.

In the write operation of the display apparatus according to this embodiment, the signal polarity of the gradation current Ipix output from the data driver 130 is switched and set in accordance with the brightness gradation value of the display data, so that a positive gradation current (source current) Ipix is supplied to the data line DL and the write current Ia corresponding to the particular gradation current Ipix is poured from the data driver 130 into the display pixel EM (pixel drive circuit DC) through the data line DL as a current source system in the low gradation area. A current sink system is employed in the middle and high gradation areas whereby a negative gradation current (sink current) Ipix is supplied to the data line DL and the write current Ia corresponding to the particular gradation current Ipix is drawn into the data driver 130 from the display pixel EM (pixel drive circuit DC) through the data line DL.

In the application using this drive control method, the relation between the gradation current Ipix and the light-emission drive current Ib in the voltage reset operation holds in such a manner that the reset voltage Vrst is set to a value at which the absolute value of the reset voltage Vrst is larger than 0 V, or preferably, to a value (for example, −5 V with the absolute value of 5 V) at which the absolute value of the potential difference between the source voltage line VL and the contact point N12 (between drain and source of the transistor Tr13) is larger than the absolute value of the threshold voltage Vth of the transistor Tr13.

Then, the current write operation is performed in such a manner that in the area low in the brightness gradation based on the display data (the low gradation area where the gradation current Ipix assumes a minuscule value), as indicated by a thin solid line (Vrst=−5V, sink current plus source current [Vth=1 V]) in FIG. 10, a minuscule positive gradation current (source current) Ipix (which is negative in the characteristic diagram of FIG. 10) is supplied from the data driver 130 to the data line DL, so that the particular gradation current Ipix is poured into the display pixel EM from the data driver 130 through the data line DL. As a result, the voltage component corresponding to the gradation current Ipix can be sufficiently held (written) within the current write operation period Tprg (=55 μsec) set as a simulation test condition, and the light-emitting operation can be so performed that a minuscule light-emission drive current Ib corresponding to the gradation current Ipix is supplied from the pixel drive circuit DC to the organic EL element OLED (specifically, the light-emission drive current from the pixel drive circuit DC to the organic EL element OLED is shut off). At the same time, the light-emission drive current Ib can be set to zero with the gradation current Ipix associated with zero gradation thereby to realize a satisfactory linearity of the light-emission drive current Ib with respect to the gradation current Ipix. Thus, the black display level (the display state at zero gradation) and the low-gradation display level can be properly set, thereby making it possible to display the image information with a high contrast.

Under the simulation test conditions described above, a gradation current Ipix of 0.5 μA (−0.5 A in FIG. 10) is poured into the display pixel EM from the data driver 130 through the data line DL, so that the voltage component corresponding to zero gradation can be written in the display pixel EM, thereby making it possible to properly set the black display level.

Also, in the middle and high gradation areas where the gradation current Ipix is comparatively large, as in the comparative object described above, a negative gradation current (sink current) Ipix (positive current in FIG. 10) is supplied and drawn into the data driver 130 from the display pixel EM through the data line DL. In this way, the substantially linear light-emission drive current Ib can be supplied to the organic EL element OLED in accordance with the particular gradation current (sink current) Ipix.

In the case where the gradation current Ipix supplied from the data driver 130 to the display pixel EM is set to have a signal polarity (positive or negative) and magnitude corresponding to the display data (brightness gradation value) (i.e., the gradation current Ipix is expanded to a negative current area of not more than zero in FIG. 10), therefore, the voltage component corresponding to the display data can be sufficiently held by the display pixel EM and the image information can be displayed with proper brightness gradation.

Further, even in the case where the threshold voltage Vth of the transistor Tr13 for light emission drive arranged in the pixel drive circuit DC of each display pixel EM undergoes a change (Vth shift) (in the case where the threshold voltage Vth changes from 1 to 3 V, for example), as shown by a thin solid line (Vrst=−5 V, sink current plus source current [Vth=1 V]) and a thick solid line (Vrst=−5 V, sink current plus source current [Vth=3 V]) in FIG. 10, the change of the light-emission drive current Ib in the low gradation area is reduced, and the brightness change of the organic EL element OLED is suppressed, thereby making possible the light-emitting operation at proper brightness gradation corresponding to the display data.

Next, the operational effects of the embodiment described above will be verified in more detail.

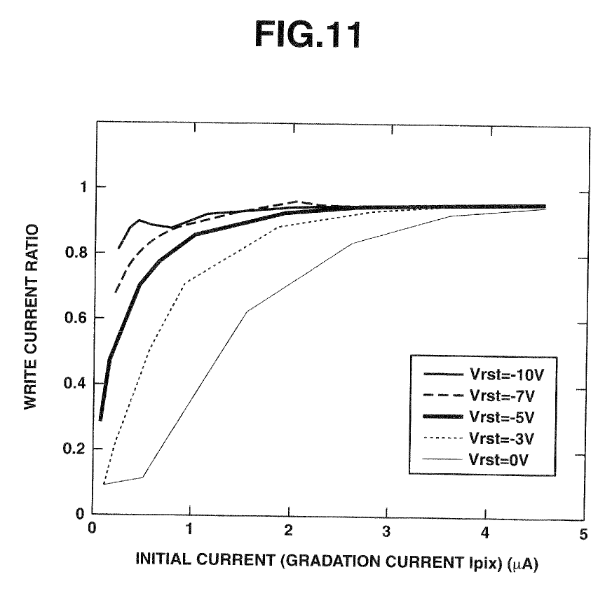

FIG. 11 is a characteristic diagram showing the relation between the voltage values applied to the data lines and the display pixels and the write ratio (write current ratio) of the gradation current supplied to the display elements in the voltage reset operation.

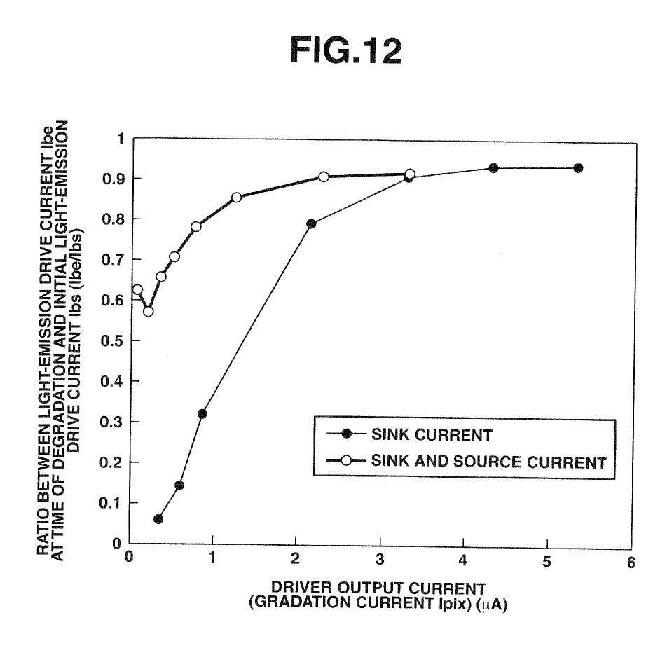

FIG. 12 is a characteristic diagram showing the relation between the presence or absence of the switch setting of the signal polarity of the gradation current and the degree of degeneration of the light-emission drive current supplied to the organic EL element (the ratio of the light-emission drive current between the initialization time and the degeneration time) in the current write operation.

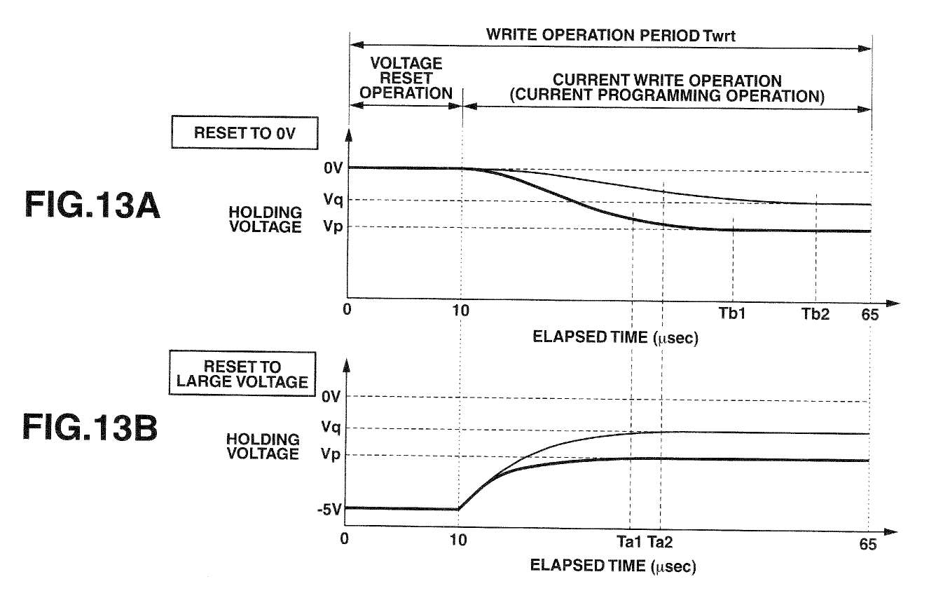

FIG. 13 is a timing chart showing the voltage change at the time of the write operation in the display apparatus according to this embodiment.

In the drive control method according to this embodiment described above, the verification of the ratio (write current ratio) of the current component actually contributing to the operation of writing in the display pixels EM to the gradation current (initial current) Ipix supplied from the data driver 130 shows that as shown in FIG. 11, the higher the absolute value of the reset voltage Vrst (the lower the reset voltage Vrst in FIG. 11), the greater the improvement of the write current ratio and the approximation to “1” in the low gradation area.

Specifically, as shown in FIG. 11, the write current ratio can be made to approach “1” in all the gradation areas (substantially all the areas of the gradation current) and the voltage component corresponding to the gradation current (initial current) Ipix can be held more satisfactorily in the case where the reset voltage Vrst is set to a lower voltage value (voltage value with a higher absolute value, or −7 V or −10 V, for example) than in the case where the reset voltage Vrst is set to 0 V or the neighborhood thereof (for example, −3 V).

Also, the verification of the degree of degeneration of the light-emission drive current Ib with respect to the gradation current Ipix according to this embodiment shows that, as shown in FIG. 12, the degree of degeneration of the light-emission drive current Ib in the low gradation area can be suppressed more in the case where the current sink system or the current source system is set by switching to each other in accordance with the brightness gradation of the display data than in the case where the gradation current Ipix is supplied using only the current sink system. The “degree of degeneration of the light-emission drive current Ib” is defined as the ratio (Ibe/Ibs) of the light-emission drive current Ibe degenerated after the change in the threshold voltage Vth to the light-emission drive current Ibs in the initial state not changed (Vth shift) in the threshold voltage Vth of the light-emission drive transistor Tr13 arranged in the pixel drive circuit DC, i.e., the degree of reduction in the light-emission drive current Ib in the degenerated state. Incidentally, according to this embodiment, FIG. 12 shows the result of the simulation test conducted on the assumption that the threshold voltage Vth in the initial state of the transistor Tr13 is 1 V and the threshold voltage Vth in the degenerated state (after change of the threshold voltage Vth [after Vth shift]) is 3 V.

Specifically, in the case where the current write operation is executed using only the current sink system, as indicated by thin solid line in FIG. 12, the degree of degeneration of the light-emission drive current Ib attributable to the change in the threshold voltage Vth is about zero and the light-emission drive current Ib (=Ibe) corresponding to the display data (gradation current Ipix) substantially fails to flow in the organic EL element OLED in the low gradation area where the gradation current Ipix is minuscule. In the case where the signal polarity of the gradation current Ipix is set by switching between the current sink system and the current source system, on the other hand, as indicated by thick solid line in FIG. 12, the degree of degeneration of the light-emission drive current Ib is generally not less than 0.6 and the light-emission drive current Ib (=Ibe) substantially corresponding to the display data (gradation current Ipix) can be supplied to the organic EL element OLED even in the low gradation area where the gradation current Ipix is minuscule.

As described above, the current write operation is carried out in such a manner that the voltage reset operation is executed using the reset voltage Vrst with the absolute value larger than zero, after which the signal polarity of the gradation current Ipix is set by switching in accordance with the brightness gradation of the display data using both the current sink system and the current source system. By doing so, the write current ratio in write operation can be improved, and the degeneration (reduction) over time of the light-emission drive current Ib with the change in the threshold voltage Vth of the light-emission drive transistor Tr13 can be suppressed more, with the result that a predetermined voltage component corresponding to the gradation current Ipix in a predetermined current write operation period Tprg can be held (written) both satisfactorily and sufficiently, while at the same time making possible the light-emitting operation of the organic EL element OLED at a proper brightness gradation corresponding to the display data.

In the write operation according to the drive control method of this embodiment, therefore, as shown in FIG. 13A, assume that the reset voltage Vrst is set to zero (expressed as “reset to 0 V” in the drawing). Then, if the threshold voltage Vth of the light-emission drive transistor Tr13 undergoes a change from 1 to 3 V, for example, the fact that the voltage applied between drain and source of the transistor Tr13 in the voltage reset operation is lower than the threshold voltage Vth makes it difficult for the current to flow between drain and source of the transistor Tr13, with the result that the reset operation cannot be performed sufficiently within the voltage reset operation period, and a comparatively long time is required for the voltage component holding operation in the subsequent current write operation. In the case where, as shown in FIG. 13B, the reset voltage Vrst is set to a lower voltage (an absolute voltage greater than zero and for which the absolute potential difference between the source voltage line VL and the contact point N12 [between drain and source of the transistor Tr13] is proximate to or larger than the absolute threshold voltage Vth of the transistor Tr13, such as −5 V) (expressed as “reset to large voltage” in the drawings), then the absolute potential difference applied between drain and source of the transistor Tr13 during the voltage reset operation becomes proximate to or greater than the absolute threshold voltage Vth. Therefore, the current easily flows between drain and source of the transistor Tr13, and the reset operation can be performed sufficiently within the voltage reset operation period. As a result, the voltage component (holding voltage) held in the display pixel EM (the capacitor Cs in the pixel drive circuit DC) in the subsequent current write operation can be quickly converged to a black display level Vp or a neighboring low gradation display level Vq from the low reset voltage (−5 V) (elapsed time Ta1<Tb1, Ta2<Tb2). Thus, the voltage component corresponding to the display data can be held (written), quickly and satisfactorily, within the predetermined current write operation period Tprg (55 μsec in this embodiment).

Although the foregoing verification of the operational effects shows the result of a simulation conducted under specified test conditions, the present inventor has confirmed that the result with a similar trend can be obtained also under other test conditions.

This application is based on Japanese Patent Application No. 2007-172317 filed on Jun. 29, 2007 and including specification, claims, drawings and summary. The disclosure of the above Japanese Patent Application is incorporated herein by reference in its entirety.

What is claimed is:

1. A display drive apparatus for driving a display pixel connected to a data line, said display pixel includes a light-emitting element and a pixel drive circuit including a light-emission drive element having a current path connected to one end of the light-emitting element, comprising:
a reset circuit which initializes the display pixel by applying a reset voltage to the display pixel through the data line, wherein the reset voltage has a voltage value that an absolute value of a potential difference applied between a control terminal of the light-emission drive element and one end of the current path connected to the one end of the light-emitting element being a larger value than an absolute value of a threshold voltage of the light-emission drive element, and has a polarity capable of discharging charge remaining in wiring capacitance of the data line and a capacitance component of the display pixel; and
a gradation current supply circuit which supplies a gradation current having a signal polarity and magnitude corresponding to a gradation value of display data through the data line to the display pixel which is initialized by the reset circuit.

2. The display drive apparatus according to claim 1, wherein the gradation current supply circuit includes:
a data current source which draws the gradation current to flow from the display pixel through the data line; and
an offset current source which pours the gradation current to flow into the display pixel through the data line.

3. The display drive apparatus according to claim 2, wherein the gradation current supply circuit has an output terminal connected to the data line, and an output of the data current source and an output of the offset current source are connected to the output terminal.

4. The display drive apparatus according to claim 2, wherein the gradation current supply circuit includes a first mode in which the gradation current is drawn to flow from the display pixel through the data line using the data current source and a second mode in which the gradation current is poured to flow into the display pixel through the data line using the offset current source, the gradation current supply circuit is set in one of the first and second mode in accordance with the gradation value of the display data.

5. The display drive apparatus according to claim 1, wherein the other end of the light-emitting element in the display pixel is connected to a reference voltage having a predetermined potential, and the reset voltage is set to a potential at which no current flows to the light-emitting element.

6. The display drive apparatus according to claim 1, wherein the absolute value of the reset voltage is larger than the absolute value of the threshold voltage of the light-emission drive element which has changed from an initial value of the threshold voltage after driving by applying the gradation current to the light-emitting element for a predetermined drive period.

7. The display drive apparatus according to claim 1, further comprising a select circuit which sets the display pixel into a selected state,
wherein the reset circuit applies the reset voltage through the data line to the display pixel which is set into the selected state, and
the gradation current supply circuit supplies the gradation current through the data line to the display pixel which is set into the selected state and applied with the reset voltage.

8. A display apparatus which displays image information, comprising:
a display panel with an array of a plurality of display pixels being arranged in the neighborhood of each of a plurality of intersections between a plurality of scanning lines and a plurality of data lines, wherein each display pixel includes a light-emitting element and a pixel drive circuit having a light-emission drive element having a current path connected to one end of the light-emitting element;
a reset circuit which initializes said each display pixel by applying a reset voltage to said each display pixel through said each data line, wherein the reset voltage has a voltage value that an absolute value of a potential difference applied between a control terminal of the light-emission drive element and one end of the current path connected to the one end of the light-emitting element being a larger value than an absolute value of a threshold voltage of the light-emission drive element, and has a polarity capable of discharging charge remaining in wiring capacitance of said each data line and a capacitance component of said each display pixel; and
a gradation current supply circuit which supplies a gradation current having a signal polarity and magnitude corresponding to a gradation value of display data through said each data line to the display pixel which is initialized by the reset circuit.

9. The display apparatus according to claim 8, wherein the gradation current supply circuit includes:
a data current source which draws the gradation current to flow from the display pixel through the data line; and
an offset current source which pours the gradation current to flow into the display pixel through the data line.

10. The display apparatus according to claim 9, wherein the gradation current supply circuit has an output terminal connected to the data line, and an output end of the data current source and an output end of the offset current source are connected to the output terminal.

11. The display apparatus according to claim 9, wherein the gradation current supply circuit includes a first mode in which the gradation current is drawn to flow from the display pixel through the data line using the data current source and a second mode in which the gradation current is poured to flow into the display pixel through the data line using the offset current source, the gradation current supply circuit is set in one of the first and second mode in accordance with the gradation value of the display data.

12. The display apparatus according to claim 8, wherein the other end of the light-emitting element in the display pixel is connected to a reference voltage having a predetermined potential, and
the reset voltage is set to a potential at which no current flows in the light-emitting element.

13. The display apparatus according to claim 8, wherein the absolute value of the reset voltage is larger than the absolute value of the threshold voltage of the light-emission drive element which has changed from an initial value of the threshold voltage after driving by application of the gradation current to the light-emitting element of said each display pixel for a predetermined drive period.

14. The display apparatus according to claim 8, further comprising a scanning drive circuit which sets said each display pixel connected to said each scanning line sequentially into a selected state by sequentially applying a scanning signal to each of said plurality of scanning lines,
wherein the reset circuit applies the reset voltage through said each data line to the display pixel which is set into the selected state, and
the gradation current supply circuit supplies the gradation current through said each data line to said each display pixel which is set into the selected state and applied with the reset voltage.

15. The display apparatus according to claim 8, wherein said each display pixel has a holding capacitance for holding charge based on the gradation current as a voltage component, and
the light-emission drive element supplies a light-emission drive current to the light-emitting element for a light-emitting operation of the light-emitting element based on the voltage component held in the holding capacitance.

16. A drive control method for a display drive apparatus for driving a display pixel connected to a data line, said display pixel includes a light-emitting element and a pixel drive circuit including a light-emission drive element having a current path connected to one end of the light-emitting element, the method comprising the steps of:
applying a reset voltage to the display pixel through the data line thereby to initialize the display pixel, wherein the reset voltage has a voltage value that an absolute value of a potential difference applied between a control terminal of the light-emission drive element and one end of the current path connected to the one end of the light-emitting element being a larger value than an absolute value of a threshold voltage of the light-emission drive element, and has a polarity capable of discharging charge remaining in wiring capacitance of the data line and a capacitance component of the display pixel; and
supplying a gradation current having a signal polarity and magnitude corresponding to a gradation value of display data to the display pixel through the data line after the initialization by applying the reset voltage.

17. The drive control method for a display drive apparatus according to claim 16,
wherein the step of supplying the gradation current to the display pixel includes a first mode in which the gradation current is drawn to flow from the display pixel through the data line and a second mode in which the gradation current is poured to flow into the display pixel through the data line, and supplying the gradation current is set in one of the first and second mode in accordance with the gradation value of the display data.

18. The drive control method for a display drive apparatus according to claim 16, further comprising the step of setting the display pixel in a select mode,
wherein the step of initializing by discharging the charge remaining in the wiring capacitance of the data line and the display pixel and the step of supplying the gradation current to the display pixel through the data line are executed while the display pixel is set in the select mode.

19. A drive control method for a display apparatus for displaying image information on a display panel with an array of a plurality of display pixels being arranged in the neighborhood of each of a plurality of intersections between a plurality of scanning lines and a plurality of data lines, wherein each display pixel includes a light-emitting element and a pixel drive circuit having a light-emission drive element having a current path connected to one of the light-emitting element, the method comprising the steps of:
initializing said each display pixel by applying a reset voltage to said each display pixel through said each data line, wherein the reset voltage has a voltage value that an absolute value of a potential difference applied between a control terminal of the light-emission drive element and one end of the current path connected to the one end of the light-emitting element being a larger value than an absolute value of a threshold voltage of the light-emission drive element, and has a polarity capable of discharging charge remaining in wiring capacitance of said each data line and a capacitance component of said each display pixel; and
supplying a gradation current having a signal polarity and magnitude corresponding to a gradation value of the display data through said each data line to said each display pixel after the initialization by applying the reset voltage.

20. The drive control method for a display apparatus according to claim 19,
wherein the step of supplying the gradation current to said each display pixel includes a first mode in which the gradation current is drawn to flow from the display pixel through the data line and a second mode in which the gradation current is poured to flow into the display pixel through the data line, and supplying the gradation current is set in one of the first and second mode in accordance with the gradation value of the display data.

21. The drive control method for a display apparatus according to claim 19, further comprising the step of sequentially setting said each display pixel connected to said each scanning line in a select mode,
wherein the step of initializing by discharging the charge remaining in the wiring capacitance of said each data line and said each display pixel and the step of supplying the gradation current to said each display pixel through said each data line are executed while the display pixel is set in the select mode.
